(19) United States
(12) Patent Application Publication
(10) Pub. No.: US 2025/0044106 A1
(43) Pub. Date: Feb. 6, 2025

(54) Map and Kinematic Prediction

(71) Applicant: Nissan North America, Inc., Franklin, TN (US)

(72) Inventors: Manh Huynh, Sunnyvale, CA (US); Christopher Ostafew, Mountain View, CA (US); Huiching Chen, San Jose, CA (US)

(21) Appl. No.: 18/228,553

(22) Filed: Jul. 31, 2023

(51) Int. Cl. G01C 21/34

(52) U.S. Cl. CPC G01C 21/3415; G01C 21/3484

(57) ABSTRACT

Map and kinematic based predictions are used for determining the trajectory of road users for use by a host vehicle. A kinematic trajectory of a road user is determined. The road user is associated with mapped lanes. At least one path of the road user is predicted using the mapped lanes. For a path of the at least one path, a probability is generated using the kinematic trajectory of the road user, wherein the probability represents how likely the road user will continue following the path. A kinematic prediction of the road user is generated using the probability corresponding to the path, wherein the kinematic prediction represents how likely the road user will follow an alternative path to the at least one path. Using at least one control system of a vehicle, a control action for the vehicle is determined using the at least one path and the kinematic prediction.

### TECHNICAL FIELD

This application relates to controlling a vehicle and, more particularly, to controlling a vehicle using map and kinematic prediction.

### BACKGROUND

For safe and reliable operation, at least some sub-systems in a vehicle may include inherent self-monitoring capabilities, issue detection capabilities, and, if possible, remediation capabilities.

Autonomous vehicles (or more broadly, autonomous driving) offer passengers the convenience of efficient and safe conveyance from one location to another. An autonomous vehicle may plan a trajectory to traverse a portion of a vehicle transportation network based on scene understanding of the portion of a vehicle transportation network.

### SUMMARY

Sub-optimal or inaccurate scene understanding may cause the programming of the vehicle to plan sub-optimal trajectories. As such, detecting, diagnosing, and possibly remedying errors related to scene misunderstanding can be advantageous in vehicle control.

The teachings herein describe the consideration of both map-based prediction, which utilizes drive lane information, and kinematic prediction, which relies on the motion of other road users for scene understanding. Through these considerations, challenges related to predicting the future trajectory of other road users, such as the potential for a road user to follow different paths or the possibility that the road user is deviating from a map lane such as by making a U-turn in an unconventional locations, crossing the path of bicycles and/or pedestrians, or backing up for parallel parking, are used to better understand the scene for generating a trajectory of a host vehicle.

A first aspect of the disclosed implementations is a method including determining a kinematic trajectory of a road user within a vehicle transportation network, associating the road user with mapped lanes of the vehicle transportation network, determining at least one path of the road user predicted using the mapped lanes, generating, for a path of the at least one path, a probability using the kinematic trajectory of the road user, wherein the probability represents how likely the road user will continue following the path, generating a kinematic prediction of the road user using the probability corresponding to the path, wherein the kinematic prediction represents how likely the road user will follow an alternative path to the at least one path, and determining, using at least one control system of a vehicle, a control action for the vehicle using the at least one path and the kinematic prediction

A second aspect of the disclosed implementations is an apparatus including a memory and a processor. The processor is configured to execute instructions stored in the memory to determine a kinematic trajectory of a road user within a vehicle transportation network, associate the road user with mapped lanes of the vehicle transportation network, determine at least one path of the road user predicted using the mapped lanes, generate, for a path of the at least one path, a probability using the kinematic trajectory of the road user, wherein the probability represents how likely the road user will continue following the path, generate a kinematic prediction of the road user using the probability corresponding to the path, wherein the kinematic prediction represents how likely the road user will follow an alternative path to the at least one path, and determine, using at least one control system of a vehicle, a control action for the vehicle using the at least one path and the kinematic prediction.

A third aspect of the disclosed implementations is a non-transitory computer-readable medium storing instructions operable to cause one or more processors to perform operations that include determining a kinematic trajectory of a road user within a vehicle transportation network, associating the road user with mapped lanes of the vehicle transportation network, determining at least one path of the road user predicted using the mapped lanes, generating, for a path of the at least one path, a probability using the kinematic trajectory of the road user, wherein the probability represents how likely the road user will continue following the path, generating a kinematic prediction of the road user using the probability corresponding to the path, wherein the kinematic prediction represents how likely the road user will follow an alternative path to the at least one path, and determining, using at least one control system of a vehicle, a control action for the vehicle using the at least one path and the kinematic prediction.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. On the contrary, the dimensions of the various features may be arbitrarily expanded or reduced for clarity. Further, like reference numbers refer to like elements throughout the drawings unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a diagram of situations of predictable responses.

FIG. 4 is an example of components of a system for an autonomous vehicle.

FIG. 5 is a flowchart of an example of a process for controlling a vehicle using map and kinematic predictions.

FIG. 6 is an example of creating and maintaining multiple hypotheses in accordance with the present disclosure.

FIG. 7 is an example of creating and maintaining a kinematic prediction in accordance with the present disclosure.

FIG. 8 is an example of components of a system for an autonomous vehicle using kinematic predictions.

### DETAILED DESCRIPTION

A vehicle (which may also be referred to herein as a host vehicle), such as an autonomous vehicle (AV) or a semi-autonomous vehicle, such as a vehicle including an advanced driver-assistance system (ADAS), may autonomously traverse a portion of a vehicle transportation network. Collectively, such vehicles may be referred to as autonomous vehicles.

The host vehicle may include one or more sensors. Traversing the vehicle transportation network may include the sensors generating or capturing sensor data, such as data corresponding to an operational environment of the vehicle, or a portion thereof. For example, the sensor data may include data corresponding to one or more external objects (or simply, objects) including other (i.e., other than the host vehicle itself) road users (such as other vehicles, bicycles, motorcycles, trucks, etc.) that may also be traversing the vehicle transportation network.

A trajectory can be planned (such as by a trajectory planner of the host vehicle) based on scene understanding. A scene can include the external objects (e.g., the road users) detected using sensors of the host vehicle, including static and dynamic objects. Scene understanding can include predicted trajectories of at least some of the other road users. A scene can also include data available in a high-definition (HD) map. The HD map can include driveline data. A driveline can be a line of a lane such that a longitudinal axis of a road user traversing the lane can be expected to align with the driveline. As such, scene understanding can include drivelines of the predicted trajectories of at least some of the other road users.

The trajectory planner can receive anticipated (i.e., predicted) trajectories of other road users of the vehicle transportation network. The trajectories can be received from another module (e.g., a world model module) of the host vehicle. For detected dynamic objects (e.g., a road user, such as a vehicle, a pedestrian, a bicycle, and the like), the world model module can maintain (e.g., predict and update) one or more respective hypothesis regarding the possible intentions of the road users. Examples of intentions (e.g., hypotheses) include stop, turn right, turn left, go straight, pass, park, and the like. A likelihood may be associated with each hypothesis. The likelihood can be updated based on observations (e.g., actual data) associated with the real-world objects received based on sensor data.

The road users can be detected based on received sensor data (also referred to herein as measurements or sensor observations). The world model module can maintain (i.e., associate and updates over time) a state for each hypothesis (e.g., intention) associated with a road user. For example, the state can include poses of the road user based on the intention of a hypothesis.

However, poor or inaccurate scene understanding (collectively, inaccurate scene understanding) may cause the trajectory planner of the vehicle to plan sub-optimal or unsafe trajectories for the host vehicle. Inaccurate scene understanding can mean, can include, or can result in the host vehicle determining predictions for at least some other road users that do not match the actual performances of the other road users.

Inaccurate scene understanding may occur in several situations. For example, inaccurate scene understanding may occur when the data in the HD map is inaccurate. For example, inaccurate scene understanding may occur if the data in the HD map is accurate, but road users drive in ways that are not according to the data in the HD map. To illustrate, and without loss of generality, a left-turn driveline at an intersection may be accurately mapped; however, most road users may drive past the mapped driveline before turning left at the interaction. It is noted that there can be a wide variance on how drivers make the turn (or confront any other driving situation or driveline). In another example, inaccurate scene understanding can occur or can manifest itself when road users follow trajectories that are different from the trajectories that the programming of the host vehicle predicted.

The teachings herein consider both map-based prediction and kinematic prediction to improve the prediction of future trajectories of other road users to better plan a host vehicle trajectory.

Although described herein with reference to an autonomous host vehicle, the techniques and apparatuses described herein may be implemented in any vehicle capable of autonomous or semi-autonomous operation. The teachings herein may be used within a vehicle transportation network, which can include any area navigable by a host vehicle.

To describe some implementations of the teachings herein in greater detail, reference is first made to the environment in which this disclosure may be implemented.

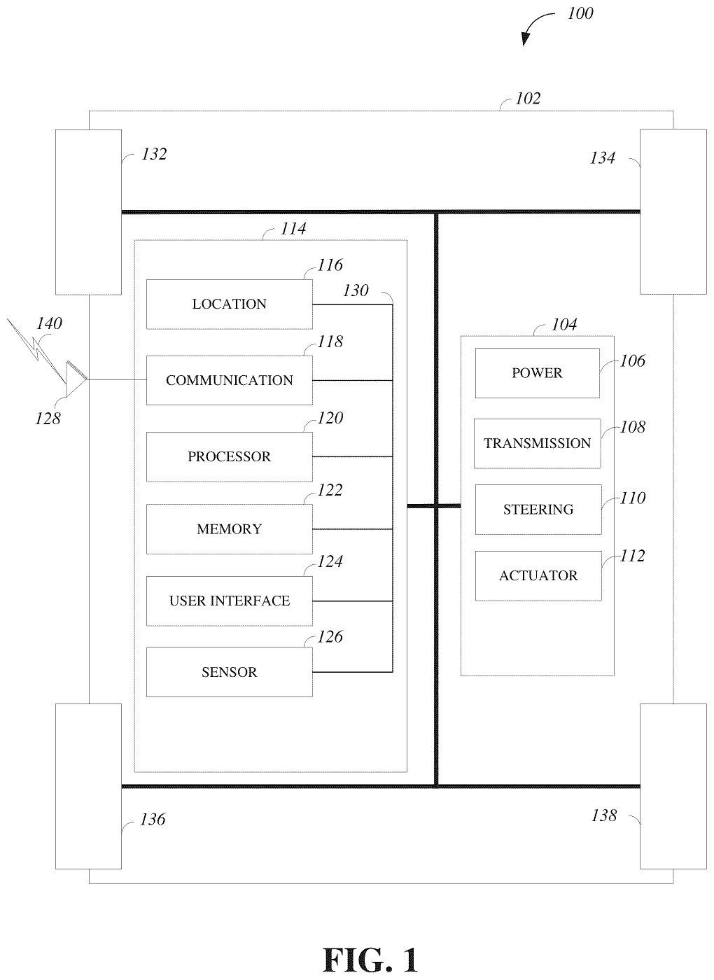

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/136/138, and may include any other element or combination of elements of a vehicle. Although the vehicle 100 is shown as including four wheels 132/134/136/138 for simplicity, any other propulsion device or devices, such as a propeller or tread, may be used. In FIG. 1, the lines interconnecting elements, such as the powertrain 104, the controller 114, and the wheels 132/134/136/138, indicate that information, such as data or control signals, power, such as electrical power or torque, or both information and power, may be communicated between the respective elements. For example, the controller 114 may receive power from the powertrain 104 and communicate with the powertrain 104, the wheels 132/134/136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor, and is operative to provide kinetic energy as a motive force to one or more of the wheels 132/134/136/138. In some embodiments, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/136/138 to steer the vehicle. The vehicle actuator 112 may receive signals from the controller 114 and may actuate or control the power source 106, the transmission 108, the steering unit 110, or any combination thereof to operate the vehicle 100.

In the illustrated embodiment, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

In some embodiments, the processor 120 includes any device or combination of devices, now-existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultra violet (UV), visible light, fiber optic, wire line, or a combination thereof. Although FIG. 1 shows a single one of the electronic communication unit 118 and a single one of the electronic communication interface 128, any number of communication units and any number of communication interfaces may be used. In some embodiments, the electronic communication unit 118 can include a dedicated short-range communications (DSRC) unit, a wireless safety unit (WSU), IEEE 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings. The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some embodiments, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller. For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

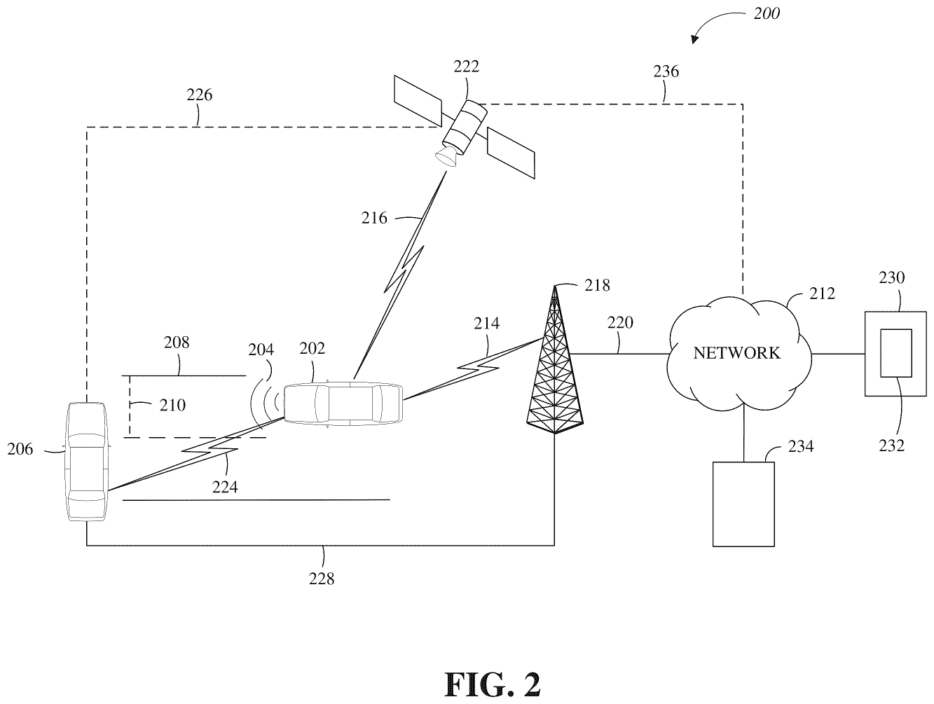

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208, and may communicate with the external object 206 via one or more of an electronic communication network 212. Although not explicitly shown in FIG. 2, a vehicle may traverse an area that is not expressly or completely included in a transportation network, such as an off-road area. In some embodiments, the transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

In some embodiments, the vehicle 202 or the external object 206 communicates via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some implementations, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some embodiments, the vehicle 202 receives a message via a third party, such as a signal repeater (not shown) or another remote vehicle (not shown). In some embodiments, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 216/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

In some embodiments, the vehicle 202 communicates with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some embodiments, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some embodiments, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

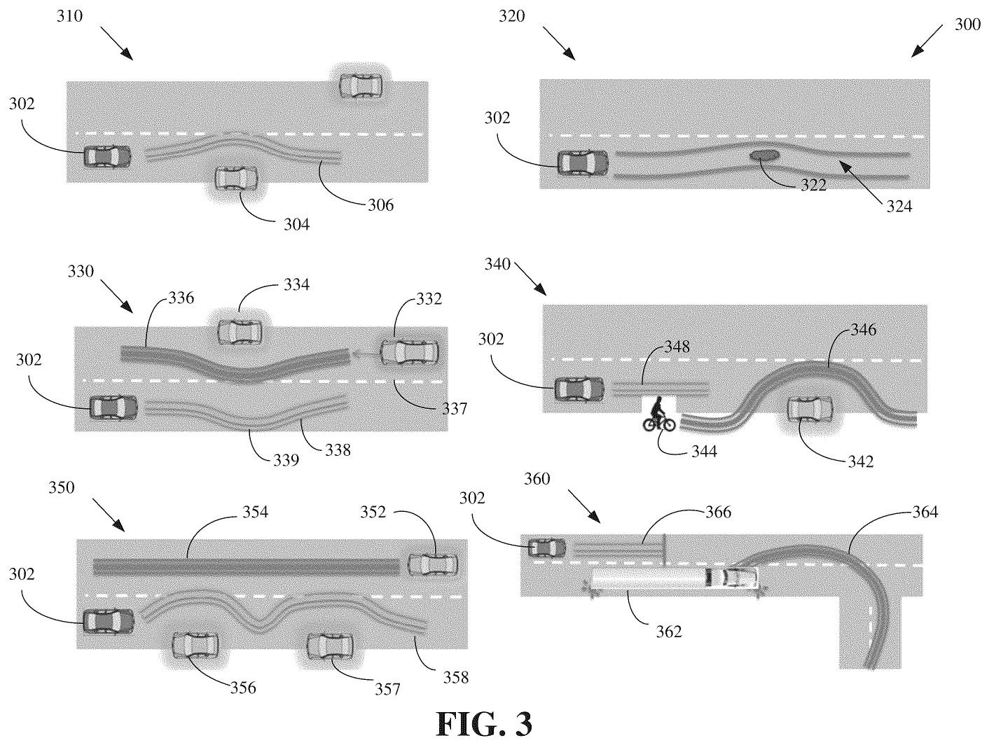

FIG. 3 is a diagram of situations 300 with predictable responses. The situations 300 include situations 310-360 in which responses of an autonomous vehicle (AV) 302 can be predicted and a trajectory planned.

The situations 300 represent examples of predictable situations and responses of road users. The situations take place (e.g., happen, occur, etc.) at a slow time scale. That is, even if the AV 302 is traveling at a high speed (e.g., 60 miles per hour (MPH)), the situations 310-360 are considered to be slow scenarios because, due to the computing power (e.g., the computing power of a processor, such as the processor 120 of FIG. 1, and/or a controller, such as the controller 114 of FIG. 1) of the AV 302, predicting responses of external objects and determining a trajectory for the autonomous vehicle can be accomplished within a sub-second of elapsed time.

The AV 302 can include a world modeling module, which can track at least some detected external objects. The world modeling module can predict one or more potential hypotheses (i.e., trajectories, paths, or the like) for each tracked object of at least some of the tracked objects. The AV 302 can include a trajectory planning system (or, simply, a trajectory planner) that can be executed by a processor to generate (considering an initial state, desired actions, and at least some tracked objects with predicted trajectories) a collision-avoiding, law-abiding, comfortable response (e.g., trajectory, path, etc.).

In the situation 310, the AV 302 detects (i.e., by the tracking component) a parked car 304 (i.e., a static object) at the side of the road. The AV 302 (i.e., the trajectory planner of the AV 302) can plan a path (i.e., a trajectory), as further described below, that navigates the AV 302 around the parked car 304, as shown by a trajectory 306.

The situation 320 is another situation where the AV 302 detects a static object. The detected static object is a pothole 322. The AV 302 can plan a trajectory 324 such that the AV 302 drives past the pothole 322 in a way that none of the tires of the AV 302 drive into the pothole 322.

In the situation 330, the AV 302 detects an oncoming vehicle 332 and a parked vehicle 334 that is on the same side of the road as the oncoming vehicle 332. The oncoming vehicle 332 is moving. As such, the oncoming vehicle 332 is a dynamic object. The oncoming vehicle 332 is moving in the same (or at least substantially the same) longitudinal direction as the AV 302. As such, the oncoming vehicle 332 can be classified as a longitudinal constraint, as further described below. The oncoming vehicle 332 is moving in the direction opposite that of the AV 302. As such, the oncoming vehicle 332 can be classified as an oncoming longitudinal constraint. The parked vehicle 334 is a static object.

The AV 302 can predict (i.e., by the prediction component), with a certain degree of certainty that exceeds a threshold, that the oncoming vehicle 332 is likely to follow a trajectory 336 to avoid (e.g., get around) the parked vehicle 334. The trajectory 336 overlaps a centerline 337 of the road. To keep a safe distance from the oncoming vehicle 332, the trajectory planner of the AV 302 can plan a trajectory 338 that includes a curvature at location 339. That is, the planned trajectory of the AV 302 moves the AV 302 to the right in anticipation of the trajectory of the oncoming vehicle 332.

In the situation 340, the tracking component of the AV 302 can detect a parked vehicle 342 (i.e., a static object) and a bicycle 344 that is moving (i.e., a dynamic object that is a longitudinal constraint). The prediction component may determine, with a certain degree of certainty, that the bicycle 344 will follow a trajectory 346 to get around the parked vehicle 342. As such, the AV 302 determines (i.e., plans, calculates, selects, generates, or otherwise determines) a trajectory 348 such that the AV 302 slows down to allow the bicycle 344 to pass the parked vehicle 342. In another example, the AV 302 can determine more than one possible trajectory. For example, the AV 302 can determine a first trajectory as described above, a second trajectory whereby the AV 302 accelerates to pass the bicycle 344 before the bicycle 344 passes the parked car, and a third trajectory whereby the AV 302 passes around the bicycle 344 as the bicycle 344 is passing the parked vehicle 342. The trajectory planner then selects one of the determined possible trajectories.

In the situation 350, the tracking component of the AV 302 detects an oncoming vehicle 352, a first parked vehicle 356, and a second parked vehicle 357. The prediction component of the AV 302 determines that the oncoming vehicle 352 is following a trajectory 354. The AV 302 selects a trajectory 358 such that the AV 302 passes the first parked vehicle 356, waits between the first parked vehicle 356 and the second parked vehicle 357 until the oncoming vehicle 352 passes, and then proceeds to pass the second parked vehicle 357.

In the situation 360, the prediction component of the AV 302 determines that a large truck 362 is most likely turning right. The trajectory planner determines (e.g., based on a motion model of a large truck) that, because a large truck requires a large turning radius, the large truck 362 is likely to follow a trajectory 364. As the trajectory 364 interferes with the trajectory or path of the AV 302, the trajectory planner of the AV 302 determines a trajectory 366 for the AV 302 such that the AV 302 is brought to a stop until the large truck 362 is out of the way.

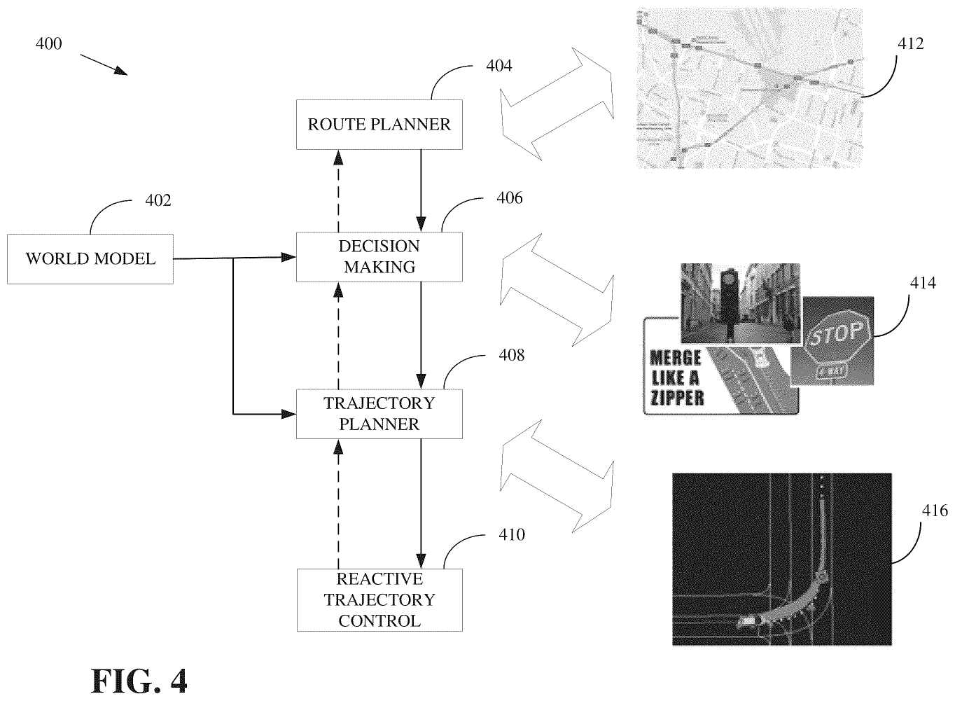

FIG. 4 is an example of components of a system 400 for an autonomous vehicle. The system 400 may represent a software pipeline of an autonomous vehicle, such as the vehicle 100 of FIG. 1. The system 400 includes a world model module 402, a route planning module 404, a decision-making module 406, a trajectory planner 408, and a reactive trajectory control module 410. Other examples of the system 400 can include more, fewer, or other modules. In some examples, the modules can be combined; in other examples, a module can be divided into one or more other modules.

The world model module 402 receives sensor data, such as from the sensor 126 of FIG. 1, and determines (e.g., converts to, detects, etc.) objects from the sensor data. That is, for example, the world model module 402 determines the road users from the received sensor data. In some implementations, the world model module 402 can convert a point cloud received from a light detection and ranging (LiDAR) sensor into an object. Sensor data from several sensors can be fused together to determine (e.g., guess the identity of) the objects. Examples of objects include a bicycle, a pedestrian, a vehicle, etc.

The world model module 402 can receive sensor information that allows the world model module 402 to calculate and maintain additional information for at least some of the detected objects. For example, the world model module 402 can maintain a state for at least some of the determined objects. For example, the state for an object can include one or more of a velocity, a pose, a geometry (such as width, height, and depth), a classification (e.g., bicycle, large truck, pedestrian, road sign, etc.), and a location. As such, the state of an object can include discrete state information (e.g., classification) and continuous state information (e.g., pose and velocity).

The world model module 402 fuses sensor information, tracks objects, maintains lists of hypotheses for at least some of the dynamic objects (e.g., an object A might be going straight, turning right, or turning left), creates and maintains predicted trajectories for each hypothesis, and maintains likelihood estimates of each hypothesis (e.g., object A is going straight with probability 90% considering the object pose/velocity and the trajectory poses/velocities). In an example, the world model module 402 uses an instance of a route planner, which generates a reference driveline for each object hypothesis for at least some of the dynamic objects. For example, one or more instances of the route planner can be used to generate reference drivelines for vehicles, bicycles, and pedestrians. In another example, an instance of the route planner can be used to generate reference drivelines for vehicles and bicycles, and a different method can be used to generate reference drivelines (e.g., references paths) for pedestrians.

The objects maintained by the world model module 402 can include static objects and/or dynamic objects.

The route planning module 404 determines a road-level plan, such as illustrated with respect to a road-level plan 412. For example, given a starting location and a destination location, the route planning module 404 determines a route from the starting location to the destination location. For example, the route planning module 404 can determine the list of roads (i.e., the road-level plan) to be followed by the AV to navigate from the starting location to the destination location.

The road-level plan determined by the route planning module 404 and the objects (and corresponding state information) maintained by the world model module 402 can be used by the decision-making module 406 to determine discrete-level decisions along the road-level plan. An example of decisions included in the discrete-level decisions is illustrated with respect to discrete decisions 414. An example of discrete-level decisions may include a decision to stop at the interaction between road A and road B, a decision to move forward slowly, a decision to accelerate to a certain speed limit, a decision to merge onto the rightmost lane, etc.

The trajectory planner 408 can receive the discrete-level decisions, the objects (and corresponding state information) maintained by the world model module 402, and the predicted trajectories and likelihoods of the external objects from the world model module 402. The trajectory planner 408 can use at least some of the received information to determine a detailed-planned trajectory for the autonomous vehicle.

For example, as illustrated with respect to a detailed-planned trajectory 416, the trajectory planner 408 determines a next-few-seconds trajectory. As such, and in an example where the next few seconds are the next 6 seconds (i.e., a look-ahead time of 6 seconds), the trajectory planner 408 determines a trajectory and locations for the autonomous vehicle in the next 6 seconds. For example, the trajectory planner 408 may determine (e.g., predict, calculate, etc.) the expected locations of the autonomous vehicle at several time intervals (e.g., every one-quarter of a second, or some other time intervals). The trajectory planner 408 can determine the detailed-planned trajectory based on predictable responses of other road users, as described, for example, with respect to FIG. 3.

The reactive trajectory control module 410 can handle situations that the autonomous vehicle may encounter but are unpredictable (e.g., cannot be handled) by the trajectory planner 408. Such situations include situations where the detailed-planned trajectory of the trajectory planner 408 was based on misclassification of objects and/or unanticipated situations that rarely occur. For example, the reactive trajectory control module 410 can modify the detailed-planned trajectory in response to determining that the static object to the left of the autonomous vehicle is misclassified. For example, the object may have been classified as a large truck; however, a new classification determines that it is a static road barrier wall. In another example, the reactive trajectory control module 410 can modify the detailed-planned trajectory in response to a sudden tire blowout of the autonomous vehicle. Other examples of unanticipated situations include other vehicles swerving suddenly (e.g., due to late decision to get to highway off-ramp or tire blowout) into the lane of the AV and pedestrians or other objects emerging suddenly from behind occlusions.

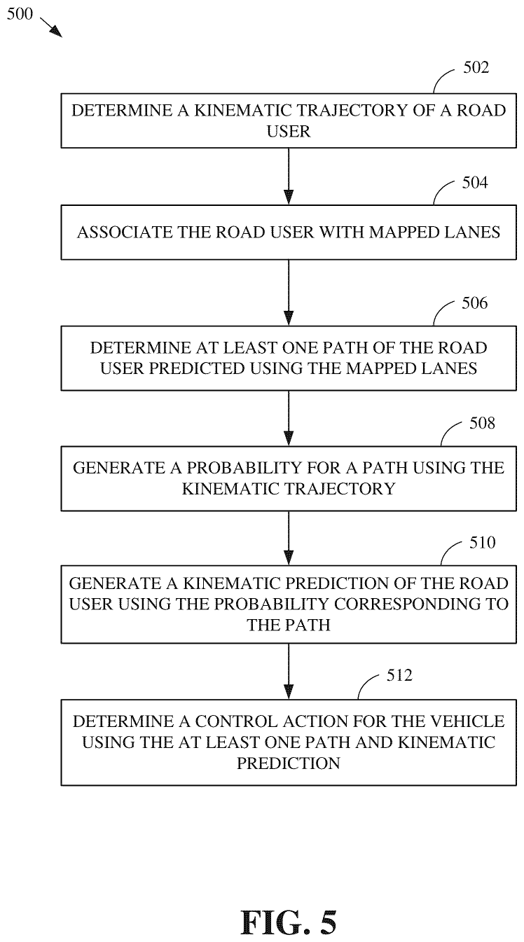

FIG. 5 is a flowchart of an example of a process 500 for controlling a vehicle using map and kinematic predictions. The process 500 includes operations 502-512, which are described below. The process 500 can be implemented in whole or in part by a world model module, such as the world model module 402 of FIG. 4. The process 500 can be stored in a memory (such as the memory 122 of FIG. 1) as instructions that can be executed by a processor (such as the processor 120 of FIG. 1) of an AV (such as the vehicle 100 of FIG. 1). The process 500 may be implemented in whole or in part by a remote support system, such as at the server computing device 234.

The process 500 may receive inputs, the inputs may include sensor data (i.e., sensor observations), such as the measurement from one or more sensors 126. The sensor data can be used to detect real-world objects. That is, for example, the sensor data can be used to determine that a real-world object exists within the view of the AV.

In an example, data from one or more cameras can be used to determine the class of a detected object. Non-limiting examples of classes include “car.” “sports car,” “sedan,” “large truck,” “pedestrian,” and “bicycle.” In another example, a classification can be assigned based on the motion, over time, of LiDAR data (e.g., a LiDAR point cloud). It is noted that different sensor data may provide different object classifications. For example, a first classification of “bicycle” may be determined based on the LiDAR data whereas a second classification of “jogger” may be determined based on camera data. Accordingly, the classification of an object may be determined probabilistically (e.g., which of the first or second classifications is more likely). As such, different sensor data may be fused together to determine the classification. As the classification is probabilistic, the classification of an object can change over time.

In an implementation, the process 500 receives, as inputs, the pose and the velocity for a detected object. In an implementation, the process 500 receives, as additional inputs, one of more of the geometry and the classification for a detected object. As such, the classification can be received as an input, rather than being determined by the process 500. The inputs may also include map information. The map information can include map lane structures (also referred to herein as road structures or mapped lanes). The map lane structure of a given lane can include successor lane information, predecessor lane information, and sibling lane information.

At operation 502, the process 500 determines the kinematic trajectory of a road user. The kinematic trajectory may be determined based on sensor data that has been fused together from multiple time periods. The kinematic trajectory for the road user may be determined from equation (1) below.

$${( {x}_{i} , {y}_{i} , {r}_{i} )}_{t : {T}_{f}} = ( {( {x}_{i} , {y}_{i} )}_{{T}_{0} : t} , {r}_{i}^{t} )$$

The function [symbol] (⋅) is described as:

$${x}_{i}^{t} = {x}_{i}^{t - 1} + {v}_{x i}^{t - 1} * Δ t$$

$${y}_{i}^{t} = {y}_{i}^{t - 1} + {v}_{y i}^{t - 1} * Δ t$$

$${r}_{i}^{t} = {r}_{i}^{t - 1} + {w}_{i}^{t - 1} * Δ t$$

In the above, (xᵢ, yᵢ)_{T}_{₀}_{:t} represents locations of the road user in the past timesteps Tₚ:t, rᵢ^{t} represents the heading angle of the object i at timestep t, (vₓ, v_{y})ᵢ represents velocities of object i in the (x, y) directions, wᵢ represents the yaw rate of the object i, and the function [symbol] (⋅) estimates a new location of the object i in future timestamp t:T_{f}.

For example, a first road user may be detected at a first time. The first road user may have an associated first position (i.e., x, y, and heading angle) an associated first velocity and an associated first yaw rate. The kinematic trajectory for the first road user at a second time may be determined, by the operation 502, using the first position, the first velocity and the first yaw rate. That is the first velocity in the x direction is added the x direction of the first position and multiplied by the change in time. The first velocity in the y direction is added the y direction of the first position and multiplied by the change in time. The first yaw rate is added the angle heading of the first position and multiplied by the change in time.

Kinematic prediction is particularly useful for object with no lane association.

At operation 504, the process 500 associates one or more road users with mapped lanes for map-based prediction. The mapped lanes may correspond to a vehicle transportation network (such as the transportation network 208) through which the AV is traversing. The road user may be associated with the mapped lanes based on the current position and trajectory of the road user. For example, the AV may detect another vehicle (i.e., the road user) on the road ahead of the AV travelling in the same direction as the AV. As such, the process 500 may associate the road user with the same lane that the AV is traveling in. In another example, the AV may detect a bicycle (i.e., road user) on the opposite side of the road, traveling in the opposition direction as the AV. The process 500 may determine that the road user is associated with a lane on the opposite side of the road. Additionally, the process 500 may determine that the road user is not associated with a mapped lane.

At operation 506, the process 500 determines at least one path of the road user predicted using the mapped lanes, defined traffic rules, and lane priorities. These predicted path(s) of the road user may be thought of as a hypothesis of the future action of the road user. For example, the process 500 can determine that there are one or more possible paths for the road user based on the associated mapped lanes. Each one of the possible paths is a hypothesis associated with the road user. Each hypothesis associated with the road user is maintained by the process 500.

To illustrate the above, an example of hypotheses maintained by the process 500 for a car (i.e., a detected object that is classified as a “car”) is now given. The hypotheses include a Hypothesis 1 and a Hypothesis 2.

Hypothesis 1 includes the discrete object state information: Classification=“Car” and Intention=“Go Straight at the next intersection.” The continuous object state information includes Position=(10, 25) (i.e., 10 meters ahead and 25 meters to the right of the AV) and Velocity=65 MPH. Hypothesis 1 can also include predictions of locations of the car for the next N seconds (i.e., the specified end time). As such, Hypothesis 1 includes object states from t=T (i.e., a current time) to t=T+N.

Hypothesis 2 includes the discrete object state information: Classification=“Car” and Intention=“Turn right at the next intersection.” The continuous object state information includes Position=(10, 25) and Velocity=45 MPH. Hypothesis 2 can also include predictions of locations of the car for the next N seconds (i.e., the specified end time). As such, Hypothesis 2 includes object states from t=T (i.e., a current time) to t=T+N. It is noted that when an object is first created, any hypotheses created for the object can have the same initial position and velocity. However, as the object is tracked (e.g., the states of the hypotheses associated with the object are updated), the positions and/or velocities associated with the different hypotheses can differ, or some hypotheses may drop off while others are added.

These hypotheses describe what actions a tracked object (e.g., a road user other than the host vehicle) can take based on the available map, and hence may be referred to as map-based predictions. Each tracked object has a predicted trajectory along at least one of the hypotheses using, for example, traffic rules and interactions with other road users. For example, a predicted trajectory may include deceleration to a stop line. More than one predicted trajectory may be determined from the hypotheses, and each hypothesis is associated with a likelihood estimation that defines how well the hypothesis explains the behavior of the object.

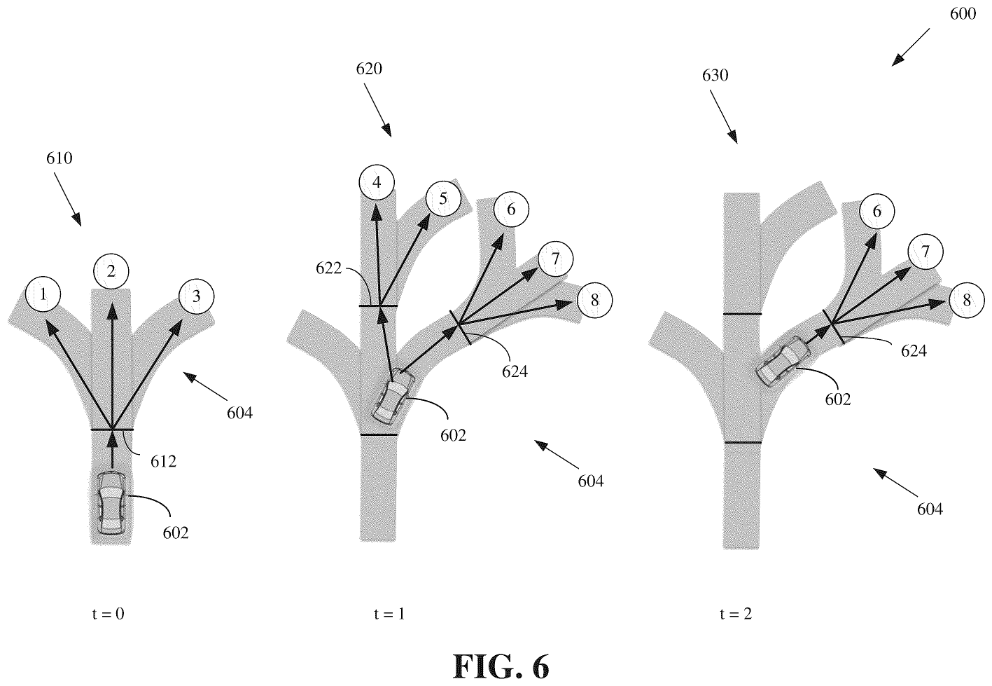

FIG. 6 is an example 600 of creating and maintaining hypotheses in accordance with the present disclosure. The example 600 depicts a vehicle 602 (i.e., a real-world object that is detected by the process 500) traversing a portion of a vehicle transportation network, namely a roadway 604.

A view 610 illustrates a position of the vehicle 602 at a time t=0. At t=0, the vehicle 602 is before a fork 612 in the roadway 604. As such, using a map lane structure obtained from the map information, the process 500 can determine that, once the vehicle 602 arrives at the fork 612, the vehicle 602 can “go left” (corresponding to a path labeled “1”), “go straight” (corresponding to a path labeled “2”), or “go right” (corresponding to a path labeled “3”). As such, the process 500 can create three hypotheses for the vehicle 602; namely a Hypothesis 1, a Hypothesis 2, and a Hypothesis 3 corresponding, respectively, to the paths labeled 1, 2, and 3. As described above, state information is determined (e.g., calculated, set, or otherwise determined) for each of the hypotheses.

A view 620 illustrates a position of the vehicle 602 at a time t=1. At t=1, as the vehicle 602 can no longer “go left,” Hypothesis 1 is removed. If the AV follows the “go straight” intention (i.e., Hypothesis 2), then using map information, the process 500 can determine that the vehicle 602 can “go straight” (corresponding to a path labeled “4”) or “go right” (corresponding to a path labeled “5”). As such, the process 500 replaces Hypothesis 2 with a Hypothesis 4 and a Hypothesis 5, respectively corresponding to the paths labeled “4” and “5” after the vehicle 602 arrives at a fork 622.

If the AV follows the “go right” intention (i.e., Hypothesis 3), then using map information, the process 500 can determine that the vehicle 602 can, after reaching a fork 624, “go left” (corresponding to a path labeled “6”), “go straight” (corresponding to a path labeled “7”), or “go right” (corresponding to a path labeled “8”). As such, the process 500 replaces Hypothesis 3 with a Hypothesis 6, a Hypothesis 7, and a Hypothesis 8, respectively corresponding to the paths labeled “6,” “7,” and “8.”

In an example, the process 500 can determine that a hypothesis for the vehicle 602 is no longer feasible (or feasible with a negligible likelihood) based on factors including a pose, a velocity, and a location of the vehicle 602. A negligible likelihood can be a likelihood that is below a threshold likelihood. More, fewer, or other factors can be used to determine the feasibility of a hypothesis. In an example, the threshold likelihood can be a threshold that is less than 10%. For example, at t=1, as the orientation of the vehicle 602 is estimated to be generally northeast and may be traveling at an estimates speed of 45 MPH, there is a negligible likelihood that the vehicle 602 can still follow the intention of Hypothesis 1.

A view 630 illustrates a position of the vehicle 602 at a time t=2. At t=2, as the vehicle 602 can no longer follow the intentions of Hypotheses 4 and 5, Hypotheses 4 and 5 are removed. Removing a hypothesis can mean setting the hypothesis to an inactive state such that the hypothesis is no longer used in the operations of the process 500.

Referring again to FIG. 5, the process 500 generates a probability for a path using the kinematic trajectory at operation 508. That is, the process 500, using an associated kinematic trajectory, determines the likelihood that the road user will continue to follow the hypothesis for each hypothesis of the road user based on the map-based predictions. The probability or likelihood [symbol] (hₘ) of the intention of a road user to follow the path (i.e., a map-based hypothesis hₘ) at timestamp t may be represented by equation (2).

$$( {h}_{m} ) = min ( ( {h}_{m} ) , {( {h}_{m} )}^{t} )$$

In equation (2), [symbol] (hₘ)^{t} is a function that estimates the probability that the object is in a drive lane at timestamp t based on lateral acceleration such that [symbol] (hₘ)^{t}→0 if the object is out of a drive lane. [symbol] (hₘ) may be calculated according to equation (3) below.

$$( {h}_{m} ) = {α𝒫}^{t - 1} ( {h}_{m} ) + ( 1 - α ) ( {h}_{m} )$$

In equation (3), a represents a smoothing parameter to eliminate paths for false-positive road users (such as bushes, trees, etc.). The smoothing factor may be a number between 0 and 1. In some embodiments, the smoothing factor is preferably between 0.7 and 0.8 inclusive.

To illustrate using the examples from FIG. 6, if Hypotheses 4, 5, 6, 7, and 8 were equally likely, then each of the Hypotheses 4, 5, 6, 7, and 8 may have an assigned probability of 20%. This may be determined using the kinematic trajectory of the road user. If the current kinematic trajectory of the road user does not negate or lower the probability that the road user will continue to follow any one of generated paths, then each hypothesis remains equally likely to occur. More specifically, without losing generality, as the road user approaches the fork 624 of FIG. 6, Hypotheses 4 and 5 will become no longer viable. The further the road user deviates from fork 602 toward 624 and away from fork 622 the lower the probability that the road user will follow Hypothesis 4 or 5. As such the probability assigned to Hypotheses 4 and 5 will continue to decrease until reaching 0.

At operation 510, the process 500 generates a kinematic prediction of the road user using the probability corresponding to the path. The kinematic prediction represents the likelihood that the road user will follow a path that is not based on the associated mapped lanes. For example, the road user may be a car traveling in the same direction as the AV. The AV determines that there are two paths for the road user to follow, as the road user approaches an intersection, based on the mapped lanes. The road user may either turn right, or the road user may turn left at the intersection. In addition to the two paths determined based on the mapped lanes, corresponding traffic rules, and lane priorities, the AV can determine that the road user may continue straight through the intersection based on its kinematic trajectory. Even though there is not a mapped lane that would allow the user to continue straight, it is a possibility.

The probability generated for the kinematic prediction is based on the probability corresponding to the paths predicted for the road user. Each path or hypothesis is divided by a threshold value to determine how likely it is that the road user will deviate from the mapped lanes and instead follow the kinematic trajectory.

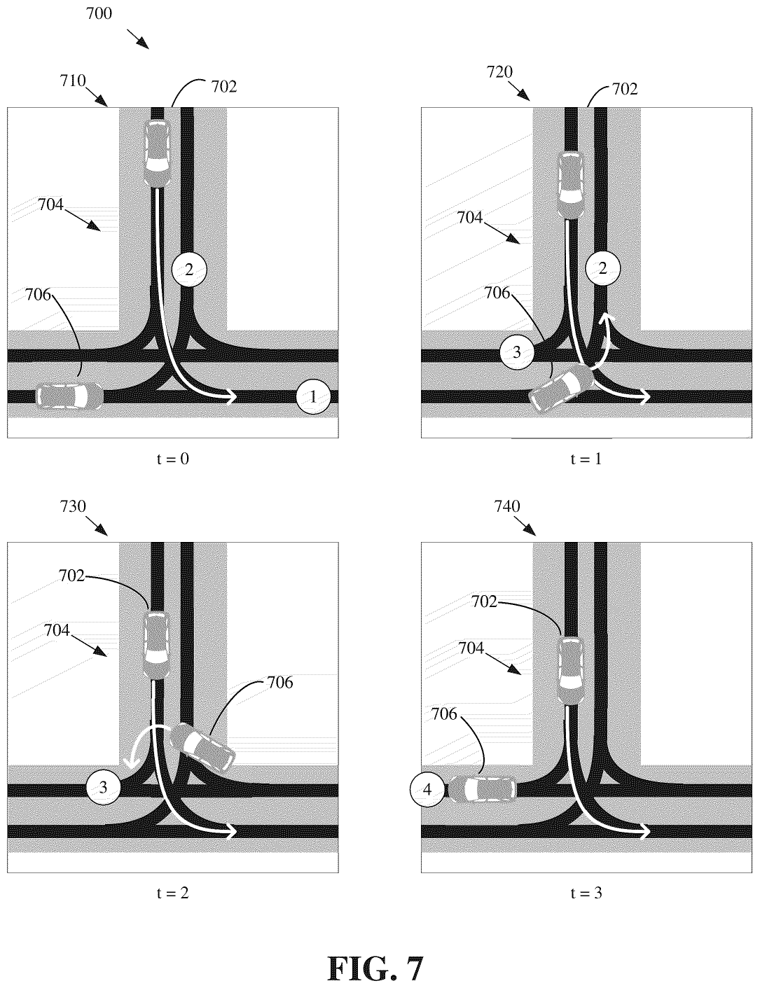

FIG. 7 is an example 700 of generating a kinematic prediction in accordance with the present disclosure. The example 700 depicts an AV 702 and a road user 706 (i.e., a real-world object that is detected by the process 500) traversing a portion of the vehicle transportation network, namely a roadway 704.

A view 710 illustrates a position of the AV 702 and the vehicle 706 at a time, t=0. At t=0, the AV 702 is approaching an intersection from one direction, while the vehicle 706 is approaching the intersection from a different direction. At t=0, the AV 702 may determine that there are 2 paths for the vehicle 706 to follow, as indicated as path 1 and path 2. Path 1 and path 2 are hypotheses generated as possible paths for the vehicle to follow. At t=0, both path 1 and path 2 are equally likely to occur. Each path is assigned a possibility of 100%. Since neither path is more likely than the other, the AV 702 cannot determine which path the vehicle will take and therefore must account for all possible paths.

Additionally, a kinematic prediction (also referred to as a kinematic trajectory likelihood estimation) [symbol] (hₖ) is determined based on the probability assigned to each hypothesis using equation (4) below.

$$( {h}_{k} ) = 1 - min ( 1 , {P ( {h}_{m} )}^{t} / s ) )$$

P(hₘ)^{t} is the map-based likelihood as described above with regards to equation (2), and s represents a threshold value. The threshold value s can be any number between 0 and 1. In some implementations, a threshold value s of 0.35 is used. Using equation (4) and the threshold value s=0.35 as an example, the kinematic prediction would be used only when the probability associated with each path (i.e., hypothesis) is below 35% or 0.35. Otherwise, the kinematic prediction becomes 0.

A view 720 illustrates a position of the AV 702 and the vehicle 706 at a time t=1. At t=1, the vehicle 706 has started to turn to the left and the process 500 has determined that the vehicle will not follow path 1 based on the kinematic trajectory of the vehicle 706. In other words, the probability associated with path 1 becomes 0. Additionally, the AV 702 has determined a third possible path as indicated by 3. Path 3 is based on the kinematic trajectory and not associated with mapped lines. For example, vehicle 706 might have started to decelerate and has started turning left along the mapped lines, as such the probability of path 1 ceased to be a viable hypothesis. Based on the new trajectory of the vehicle 706, the process 500 has generated a kinematic prediction, path 3, that is not associated with mapped lines in which the vehicle 706 could follow. Because the vehicle 706 has not deviated from the mapped lanes at this point, the kinematic prediction would remain 0.

A view 730 illustrates a position of the AV 702 and the vehicle 706 at a time t=2. At time t=2, the vehicle 706 has continued turning left beyond the confines of the mapped lane. As such the probability associated with path 2 drops below the threshold value. When the probability drops below the threshold value, the kinematic prediction becomes greater than 0. This indicates that the vehicle 706 might be taking an action that is not associated with a mapped lane such that the trajectory is therefore based on the kinematic trajectory.

A view 740 illustrates a position of the AV 702 and the vehicle 706 at a time t=3. At time t=3, the vehicle 706 has continued turning left and performs a U-turn such that the vehicle 706 is now facing the opposite direction from where it started in view 710 at time t=0.

Referring again to FIG. 5, the process 500 determines a control action for the AV using the paths and the kinematic prediction at operation 512. In other words, a control system, such as the controller 114 of FIG. 1, may determine that the AV needs to accelerate or decelerate to avoid a collision with the road user. For example, the process 500 may determine that the AV 702 of FIG. 700 is required to slow down so as not to collide with the vehicle 706 while the vehicle 706 performs a U-turn across the path of the AV 702.

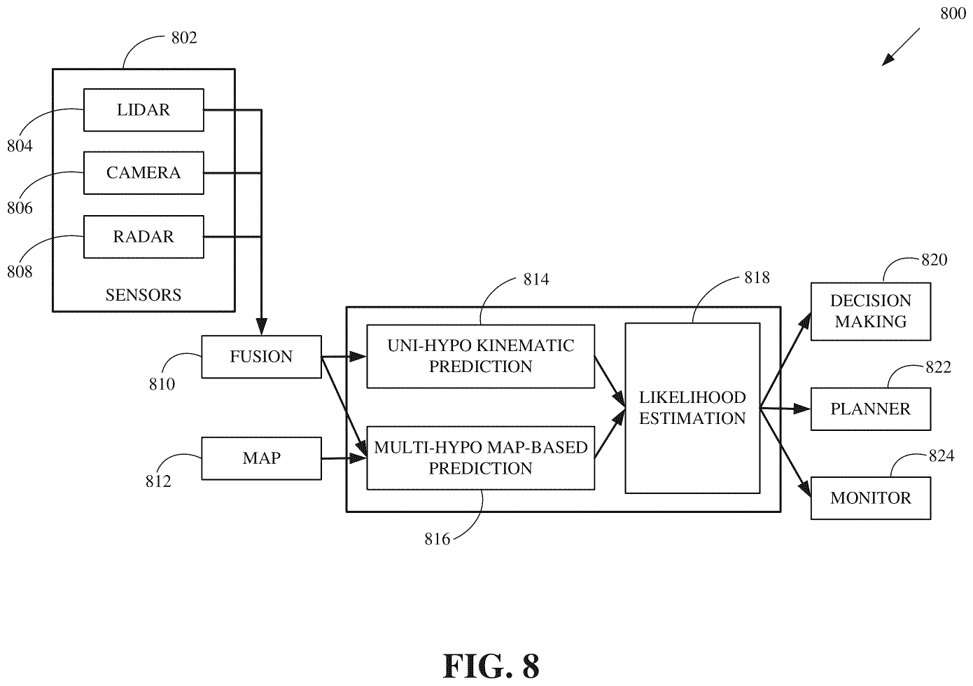

FIG. 8 is an example of components of a subsystem 800 for an AV. The subsystem 800 represents a subsection of the software pipeline of an AV, such as the world model module 402 of FIG. 4 of the vehicle 100 of FIG. 1. The subsystem 800 includes input from sensors 802 (including but not limited to lidar 804, a camera 806, a radar 808, or the like), which may be similar to the sensors 126 of FIG. 1, a fusion module 810, and a map 812. The inputs are used to generate a uni-hypothesis kinematic prediction 814, a multi-hypothesis map-based prediction 816, and a likelihood estimation 818.

The likelihood estimation 818 generated by the subsystem is output to a decision-making module 820, which may be similar to the decision-making module 406 of FIG. 4, a planner 822 which may be similar to the route planner 404 or the trajectory planner 408 or FIG. 4, and a monitor 824. Other examples of the subsystem 800 can include more, fewer, or other modules and/or inputs and outputs. In some examples, the modules can be combined. In other examples, a module can be divided into one or more other modules.

Data from different sensors, such as the sensors 802, are fused together by the fusion module 810. The fused data is used to detect a road user. The fused data, the detected road user, and the map data from the map module 812 are combined to generate multiple map-based predictions (i.e., multi-hypo map-based prediction 816). The multiple map-based predictions are the result of operation 506 and operation 508 of process 500 of FIG. 5.

The fused data from the fusion module 810 is also used to generate a single hypothesis kinematic prediction (i.e., a uni-hypothesis kinematic prediction 816). The single hypothesis kinematic prediction 814 is generated using operation 510 of process 500 of FIG. 5, for example. The single hypothesis kinematic prediction and the multiple map-based predictions are combined to determine a likelihood estimation 818.

The likelihood estimation 818 may then be output to the decision-making module 820, the planner module 822, the monitor 824, or any combination thereof. The decision-making module 820 may use the likelihood estimation 818 to determine how the AV may react to the road user. For example, if the likelihood estimation determines that the road user is likely to stop abruptly in front of the AV, the decision-making module 820 may determine that the AV needs to brake. Alternatively, the decision-making module 820 may determine that the best course of action is to change lanes to go around the stopping vehicle. In this example, the planner module 822 may also use the likelihood estimation 818 to plan a route for changing lanes around the stopping vehicle.

For simplicity of explanation, the technique 500 is depicted and described as a series of operations. However, the operations in accordance with this disclosure can occur in various orders and/or concurrently. Additionally, other steps or operations not presented and described herein may be used. Furthermore, not all illustrated operations may be required to implement a technique in accordance with the disclosed subject matter.

As used herein, the terminology “driver” or “operator” may be used interchangeably. As used herein, the terminology “brake” or “decelerate” may be used interchangeably. As used herein, the terminology “computer” or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some implementations, instructions, or a portion thereof, may be implemented as a special-purpose processor or circuitry that may include specialized hardware for carrying out any of the methods, algorithms, aspects, or combinations thereof, as described herein. In some implementations, portions of the instructions may be distributed across multiple processors on a single device, or on multiple devices, which may communicate directly or across a network, such as a local area network, a wide area network, the Internet, or a combination thereof.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
determining a kinematic trajectory of a road user within a vehicle transportation network;
associating the road user with mapped lanes of the vehicle transportation network;
determining at least one path of the road user predicted using the mapped lanes;
generating, for a path of the at least one path, a probability using the kinematic trajectory of the road user, wherein the probability represents how likely the road user will continue following the path;
generating a kinematic prediction of the road user using the probability corresponding to the path, wherein the kinematic prediction represents how likely the road user will follow an alternative path to the at least one path; and
determining, using at least one control system of a vehicle, a control action for the vehicle using the at least one path and the kinematic prediction.

2. The method of claim 1, wherein the kinematic prediction is generated by dividing the probability corresponding to the path by a threshold value.

3. The method of claim 1, wherein the probability corresponding to the path is multiplied by a smoothing factor.

4. The method of claim 1, wherein the kinematic trajectory of the road user is determined using a first heading and a first angle of the road user measured at a first time in relation to a second heading and a second angle of the road user measured at a second time.

5. The method of claim 1, wherein the at least one path is determined based on defined traffic rules and lane priority rules for the mapped lanes.

6. The method of claim 2, wherein the threshold value is a number between 0 and 1.

7. The method of claim 3, wherein the smoothing factor is a number between 0 and 1.

8. An apparatus, comprising:
a memory; and
a processor configured to execute instructions stored in the memory to:
determine a kinematic trajectory of a road user within a vehicle transportation network;
associate the road user with mapped lanes of the vehicle transportation network;
determine at least one path of the road user predicted using the mapped lanes;
generate, for a path of the at least one path, a probability using the kinematic trajectory of the road user, wherein the probability represents how likely the road user will continue following the path;
generate a kinematic prediction of the road user using the probability corresponding to the path, wherein the kinematic prediction represents how likely the road user will follow an alternative path to the at least one path; and
determine, using at least one control system of a vehicle, a control action for the vehicle using the at least one path and the kinematic prediction.

9. The apparatus of claim 8, wherein the kinematic prediction is generated by dividing the probability corresponding to the path by a threshold value.

10. The apparatus of claim 8, wherein the probability corresponding to the one or more map-based prediction is multiplied by a smoothing factor.

11. The apparatus of claim 8, wherein the kinematic trajectory of the road user is determined using a first heading and a first angle of the road user measured at a first time in relation to a second heading and a second angle of the road user measured at a second time.

12. The apparatus of claim 8, wherein the at least one path is determined based on defined traffic rules and lane priority rules for the mapped lanes.

13. The apparatus of claim 9, wherein the threshold value is a number between 0 and 1.

14. The apparatus of claim 10, wherein the smoothing factor is a number between 0 and 1.

15. A non-transitory computer-readable medium storing instructions operable to cause one or more processors to perform operations comprising:
determining a kinematic trajectory of a road user within a vehicle transportation network;
associating the road user with mapped lanes of the vehicle transportation network;
determining at least one path of the road user predicted using the mapped lanes;
generating, for a path of the at least one path, a probability using the kinematic trajectory of the road user, wherein the probability represents how likely the road user will continue following the path;
generating a kinematic prediction of the road user using the probability corresponding to the path, wherein the kinematic prediction represents how likely the road user will follow an alternative path to the at least one path; and
determining, using at least one control system of a vehicle, a control action for the vehicle using the at least one path and the kinematic prediction.

16. The non-transitory computer readable medium storing instructions of claim 15, wherein the kinematic prediction is generated by dividing the probability corresponding to the path by a threshold value.

17. The non-transitory computer readable medium storing instructions of claim 15, wherein the kinematic trajectory of the road user is determined using a first heading and a first angle of the road user measured at a first time in relation to a second heading and a second angle of the road user measured at a second time.

18. The non-transitory computer readable medium storing instructions claim 15, wherein the at least one path is determined based on defined traffic rules and lane priority rules for the mapped lanes.

19. The non-transitory computer readable medium storing instructions of claim 16 wherein the probability corresponding to the path is multiplied by a smoothing factor.

20. The non-transitory computer readable medium storing instructions of claim 19, wherein the threshold value is a first number between 0 and 1 and the smoothing factor is a second number between 0 and 1.
